(19) United States
(12) Patent Application Publication
(10) Pub. No.: US 2007/0266225 A1
(43) Pub. Date: Nov. 15, 2007

(54) Microcontroller unit

(76) Inventors: Tak Kwan Vincent Ko, Laguna City (HK); Yat Ho Cheng, Kwai Chung (HK); Edward J. Hathaway, Austin, TX (US); Stephen Pickering, Avongrove (GB); Michael C. Wood, Pflugerville, TX (US)

Correspondence Address: FREESCALE SEMICONDUCTOR, INC.;LAW DEPARTMENT, 7700 WEST PARMER LANE MD:TX32/PL02, AUSTIN, TX, 78729, US

(21) Appl. No.: 11/430,658

(22) Filed: May 9, 2006

(51) Int. Cl. G06F 15/00

(52) U.S. Cl. 712/220

(57) ABSTRACT

A microcontroller unit (MCU) includes a CPU, a system integration module (SIM), and a memory. The CPU decodes instructions to determine the function, an addressing type and an operand address, and converts the operand address to a first address. The SIM converts the first address to a memory address. The memory has a first section addressable via a tiny addressing mode and a second section addressable via a short addressing mode. The tiny and short address spaces can be addressed by a single instruction word. The remaining memory locations can be accessed via alternative addressing modes, such as indirect addressing and paging. The first and second memory sections include mapped registers for indirect addressing, index addressing and paging.

### BACKGROUND OF THE INVENTION

The present invention relates to microcontrollers and memory access schemes and, more particularly, to optimization of memory addressing in microcontrollers.

A microcontroller or microcontroller unit (MCU) is an integrated circuit (IC) that contains many of the functions found in a typical computer system. A microcontroller uses a microprocessor as its central processing unit (CPU) and incorporates features such as memory, a timing reference, and input/output peripherals, all on the same chip. Microcontrollers are very useful in any application in which many decisions or calculations are required. In most cases, it is easier to use the computational power of a microcontroller than discrete logic. Some typical Microcontroller applications include telephones, answering Machines, pagers, motor control, appliances, remote control devices, toys, automotive electronics, etc.

Every year 8-bit microcontrollers move into smaller and smaller applications in which the robust functions and large memory sizes of typical microcontrollers are not required. Further, as 8-bit microcontrollers are used in more compact, battery-powered systems, optimized power-efficient cores become crucial to the end product's success. Thus, there is a need for a small and low power microcontroller. Such small size microcontrollers provide an ideal solution for emerging applications, such as simple electromechanical devices that are migrating to fully solid-state electronic operation, or portable devices that have evolved into smaller or even disposable versions.

### BRIEF DESCRIPTION OF THE DRAWINGS

The following detailed description of preferred embodiments of the invention will be better understood when read in conjunction with the appended drawings. The present invention is illustrated by way of example and is not limited by the accompanying figures. It is to be understood that the drawings are not to scale and have been simplified for ease of understanding the invention.

FIG. 1 is a schematic block diagram of a microcontroller in accordance with an embodiment of the present invention;

FIGS. 2A and 2B illustrate instruction words in accordance with an embodiment of the present invention;

FIG. 3 is a schematic block diagram of a central processing unit in accordance with an embodiment of the present invention;

FIG. 4 is a block diagram illustrating a portion of a memory in accordance with an embodiment of the present invention;

FIG. 5 is block diagram illustrating a map of a memory in accordance with an embodiment of the present invention; and

FIG. 6 is a schematic diagram illustrating the operation of a system integration module in accordance with an embodiment of the present invention.

### DETAILED DESCRIPTION OF THE INVENTION

The detailed description set forth below in connection with the appended drawings is intended as a description of the presently preferred embodiments of the invention, and is not intended to represent the only form in which the present invention may be practiced. It is to be understood that the same or equivalent functions may be accomplished by different embodiments that are intended to be encompassed within the spirit and scope of the invention. In the drawings, like numerals are used to indicate like elements throughout.

The present invention provides a microcontroller that is a simplified version of a higher-performance architecture. The core is smaller and features a condensed instruction set, allowing compact and efficient coding of embedded applications in small pin count devices. The present invention also provides efficient methods of accessing memory spaces using single byte instructions.

In one embodiment, the present invention is a single chip microcontroller unit (MCU), comprising a central processing unit (CPU), a system integration module (SIM), and a memory. The CPU processes eight-bit instructions, wherein each instruction includes an instruction operation code (opcode). The opcode designates a function and an addressing mode. The CPU decodes the opcode to determine the instruction function, the addressing mode, and an operand address. In a tiny addressing mode, the least significant four bits of the instruction are the operand address. In a short addressing mode, the least significant five bits of the instruction are the operand address, and in a direct addressing mode, the operand address is the eight bits that follow the instruction. The CPU converts the operand address into a first address. The SIM, which is coupled to the CPU, receives the first address from the CPU and converts the first address to a memory address. The memory is coupled to the SIM with a 14-bit address bus and to the CPU with an 8-bit data bus. The memory is accessed using the memory address from the SIM and data stored in the memory is provided to the CPU. Memory addresses used herein are designated in hexadecimal.

The present invention further provides a method of accessing an operand stored in a memory, comprising the steps of decoding an instruction to determine an opcode and an addressing type of the instruction, wherein in a tiny addressing mode the opcode indicates that the operand is located in a first predetermined section of the memory, and in a short addressing mode the opcode indicates that the operand is located in a second predetermined section of memory; and generating an operand address. In the tiny addressing mode the operand address is a first predetermined number of bits of the instruction, and in the short addressing mode the operand address is a second predetermined number of bits of the instruction.

A detailed description of the present invention is provided below. In the description, the invention is described in terms of an 8-bit MCU with a 16K×8 memory. However, it will be understood by those of skill in the art that the memory accessing techniques described herein may be applied to more robust microcontrollers with larger memories and wider words (e.g., a 16-bit or 32-bit microprocessor), as well as other types of processors and systems. Certain registers are mapped to memory locations and specific examples are provided for memory locations of the mapped registers. However, it should be understood that such memory mapped registers may reside in other memory addresses. Thus, such memory addresses are exemplary. Instruction mnemonics also are used in the description that follows. In one embodiment of the invention, the invention is a scaled down version of a robust MCU, like the HC08 and HCS08 microcontrollers available from Freescale Semiconductor, Inc. of Austin, Tex. While those of skill in the art will readily understand the mnemonics used below, a more detailed understanding of such mnemonics may be found in the literature available from Freescale describing its microcontrollers.

Referring now to FIG. 1, a microcontroller unit (MCU) 10 in accordance with an embodiment of the present invention is shown. The MCU 10 includes a central processor unit (CPU) 12, a system integration module (SIM) 14, and a memory 16. The MCU 10 preferably is formed on a single chip and employs a Von Neumann architecture with a shared program and data bus. More particularly, the CPU 12 is coupled to the memory 16 by a data bus 18. In the embodiment described herein, the data bus 18 is eight bits wide. The CPU 12 processes eight-bit instructions received from the memory 16 via the data bus 18. Each instruction includes an instruction operation code (opcode) that designates a function and an addressing mode. The CPU 12 decodes the opcode to determine the instruction function, the addressing mode, and an operand address. The SIM 14 is coupled to the CPU 12, receives the operand address from the CPU 12, and converts the operand address to a memory address. The memory address is provided from the SIM 14 to the memory 16 via an address bus 19. The memory address is used to access data (e.g., the instruction operand) stored in the memory 16. In the presently preferred embodiment, the memory address is 14 bits and the memory address bus 19 is fourteen bits wide, which allows for a 16 k addressable memory space, and since the data bus 18 is eight bits wide, the memory 16 is 16 k×8. The memory 16 may be a single memory device, a mix of different kinds of memory arrays, like Flash, RAM, OTP, and other memory mapped peripheral modules, such as ADC or timer. In other embodiments, the memory address bus is wider and additional devices are coupled to the memory address bus and the data bus, such as other memories and peripheral devices.

In order to make the program code executed by the MCU 10 efficient, the usage of memory is made efficient by defining a tiny addressing mode for accessing a first predefined area of the memory 16 and a short addressing mode for accessing a second predefined area of the memory 16. In a presently preferred embodiment of the invention, the tiny addressing mode is able to address the first sixteen (16) memory locations and the short addressing mode is able to address the first thirty-two (32) memory locations. In other embodiments of the invention, the tiny and short addressing modes could be used to access, for example, 32-bytes and 64-bytes, respectively.

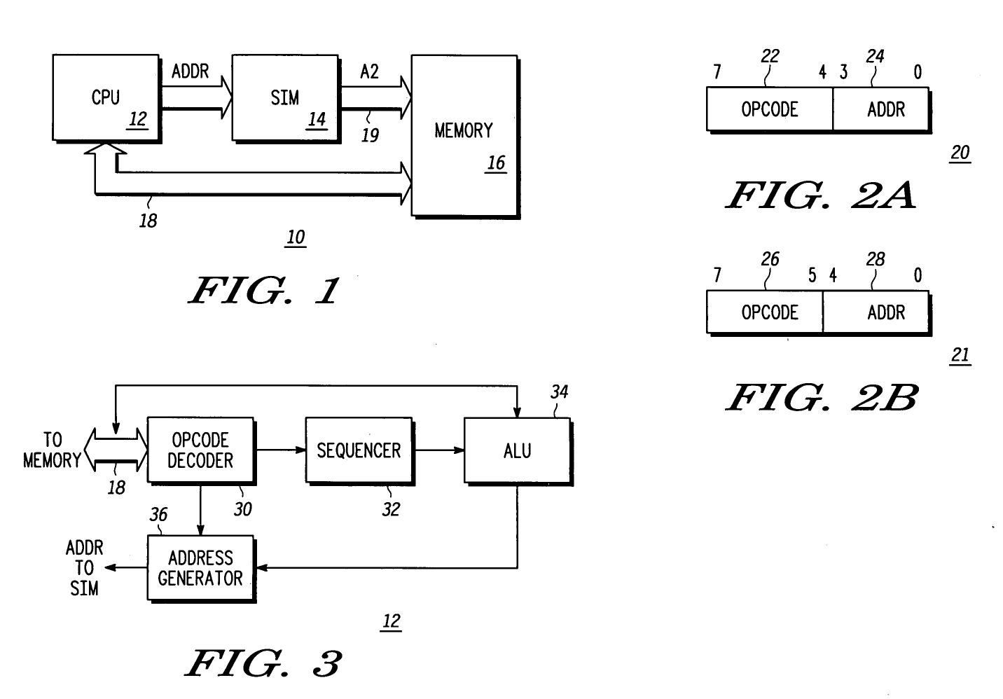

Referring now to FIGS. 2A and 2B, two examples of instruction word formats 20 and 21 are shown. In FIG. 2A, the instruction word 20 is eight bits and includes a four bit opcode 22 and a four bit operand address 24. The four bit operand address allows sixteen memory locations to be accessed, thus the instruction opcode 22 would indicate the tiny addressing mode. In the presently preferred embodiment, the tiny addressing mode is capable of addressing only the first sixteen bytes in the address map, from $0000 to $000F. Instructions that would use the tiny addressing mode are INC, DEC, ADD and SUB. Program code can be optimized by placing the most computation intensive data in this area of memory ($0000 to $000F). As the four-bit address is part of the instruction, only the least significant four bits of the address must be included in the instruction, which saves program space and execution time. As discussed in more detail below, the CPU 12 adds ten high order zeros to the four bit operand address and uses the combined fourteen bit address to access the intended operand.

In FIG. 2B, the instruction word 21 is eight bits and includes a three bit opcode 26 and a five bit operand address 28. The five bit operand address allows thirty-two memory locations to be accessed, thus the instruction opcode 26 would indicate the short addressing mode. In the presently preferred embodiment, the short addressing mode is capable of addressing only the first thirty-two bytes in the address map, from $0000 to $001F. Instructions that would use the short addressing mode are CLR, LDA, and STA. Similar to the tiny addressing mode, program code can be optimized by placing the most computation intensive data in this area of memory ($0000 to $001F). As discussed in more detail below, the CPU 12 adds nine high order zeros to the five bit operand address and uses the combined fourteen bit address to access the intended operand.

The microcontroller 10 uses a direct addressing mode to access operands located in a direct address space, which in one embodiment is locations $0000 to $00FF. In the direct addressing mode, the operand address follows the instruction word. In the direct addressing mode, the CPU 12 adds six high-order zeros to the low byte of the direct address operand to form a fourteen bit address to access the memory 16. In an extended addressing mode, a fourteen bit operand address is provided in low-order fourteen bits of the two bytes that follow the instruction word (i.e., after the opcode). The extended addressing mode is used by jump type instructions (i.e., JSR and JMP). Other addressing modes are supported and will be discussed in below.

Referring now to FIG. 3, a schematic block diagram of the CPU 12 is shown. The CPU 12 includes an opcode decoder 30, a sequencer 32, an arithmetic and logic unit (ALU) 34, and an address generator 36. As these functional units generally are well known in the art, only a brief description herein is required for a complete understanding of the invention. The opcode decoder 30 receives each instruction word via the data bus 18 and decodes the instruction word to form the opcode, determine the addressing mode, and generate the operand address. The sequencer 32 is coupled to the opcode decoder 30 and receives the opcode from the opcode decoder 30. The sequencer 32 uses the opcode to determine a function of the instruction and generate ALU control signals. The ALU 34 is coupled to the sequencer 32 and receives the ALU control signals from the sequencer 32. The ALU 34 also is coupled to the data bus 18 so that it can receive instructions and data from the memory 16, and to pass data to the memory 16. The ALU 34 performs operations as designated by the instruction and as specified by the control signals received from the sequencer 32. The address generator 36 is coupled to the opcode decoder 30 and receives an indication of the addressing mode and the operand address from the decoder 30. More particularly, as discussed above, depending on the addressing mode, the address generator 36 adds either ten, nine or six leading zeros to the operand address to form a fourteen bit first address. The address generator 36 also receives a control signal from the ALU 34 that indicates whether an instruction needs to be fetched from the memory 36.

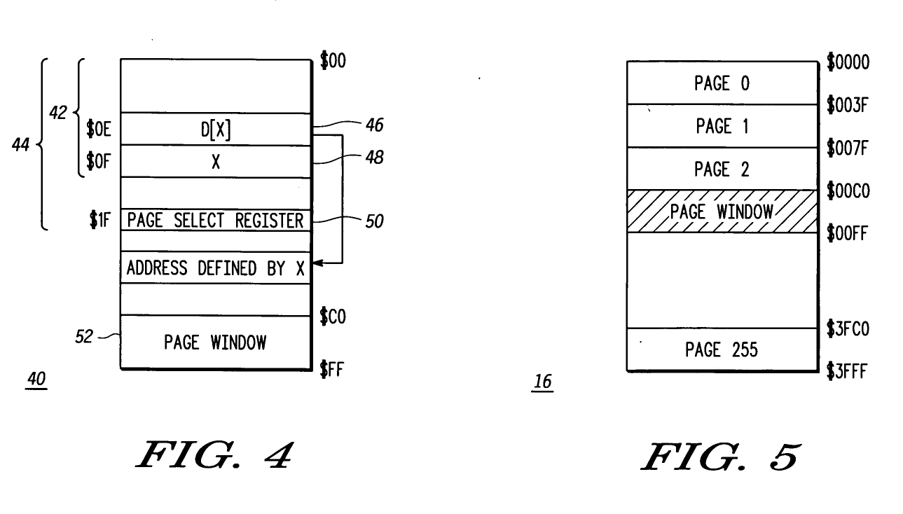

Referring now to FIG. 4, a map 40 of a portion of the memory 16 is shown. The portion of the memory 16 shown is the memory space addressable using the direct addressing mode, namely, locations $0000 to $00FF. The map 40 includes a first space 42 that is accessible via the tiny addressing mode and a second space 44 that is accessible via the short addressing mode. In the embodiment shown, the tiny addressing mode can access memory locations $00 to $0F and the short addressing mode can access memory locations $00 to $1F.

The map 40 also shows that the memory 16 includes a first predetermined address for operating as an indirect data register (denoted as D[x]) 46, and a second predetermined address for accessing an index register (denoted as “X”) 48. In the presently preferred embodiment, the indirect data register 46 is located at address $0E and the index register is located at address $0F. In an indirect addressing mode (also referred to as index addressing mode), the index register 48 contains a memory address and the indirect data register 46 contains a contents of the memory address pointed to by the index register. In the indirect addressing mode, the operand address is computed during program execution based on the current contents of the index register 48, as opposed to being a constant address location determined during program assembly. This allows a program to access different operand locations depending on the results of earlier program instructions (rather than accessing a location that was determined when the program was written). By programming the index register 48, any location in the direct page can be read/written using the indirect data register 46. Those of skill in the art will be aware of the D[X] and x registers and their operation.

The memory 16 also includes a third predetermined address for accessing a page select register 50. The page select register 50 is an eight bit index register that allows access to all memory locations in the entire 16 k-byte address space through a page window 52. That is, the page select register 50 defines which page is to be accessed through the page window. In the embodiment shown, the page select register 50 is located at the memory mapped location $1F and the page window extends from $C0 to $FF. Although not required, it is preferred that the indirect data register 46, the index register 48 and the page select register 50 (i.e., the first, second and third predetermined addresses) are within the memory 44 area accessible in the short addressing mode, and the indirect data register 46, the index register 48 (i.e., the first and second predetermined addresses) are within the memory area 42 accessible in the tiny addressing mode.

FIG. 5 shows how the memory 16 is broken up into a plurality of pages, with the page size being the maximum physical address of the processor divided by a sum of the maximum value of the page select register plus one. In the embodiment shown, each page is 64 bytes (i.e., page size=16 k/(255+1)=64). The first, second, third and fourth pages are accessible using direct addressing. The pages are accessed using paging address mode, in which the index register 48 is used to generate a page address. X[7:6] denotes the first through fourth pages (i.e., “00”=page0, “01”=page1, “10”=page2 and “11”=page3). As discussed in more detail below, if X[7:6]=“11” then page3 is accessed and the memory address is generated using the data stored in the page select register 50 and the index register 48 (memory address [13:6]=page select register and memory address [5:0]=X[5:0]). Although the indirect data register 46, the index register 48 and the page select register 50 are shown as located in the memory 16, it will be understood by those of skill in the art that these registers may be located within the CPU 12 or the SIM 14, but have the memory mapped locations as shown in FIG. 4.

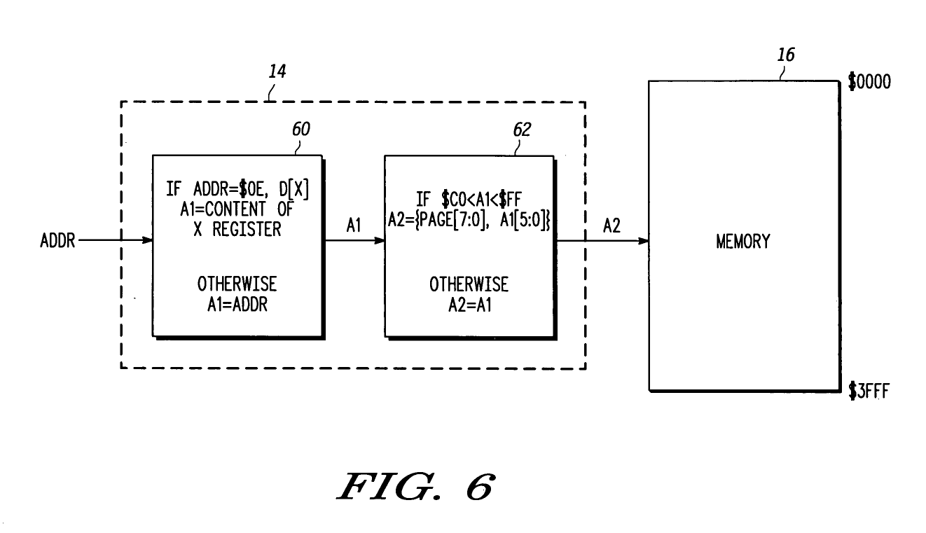

Referring now to FIG. 6, schematic diagram illustrating the operation of the SIM 14 is shown. As previously discussed, an instruction includes an operand address that stripped from the instruction by the opcode decoder 30 and provided to the address generator 36. The address generator 36 converts the operand address to a fourteen bit first address, usually by padding the operand address with a number of zeros. The SIM 14 receives the fourteen bit first address from the address generator 36 and translates the first address into a memory address (A2 in FIG. 6), which is used to access the memory 16. As is understood by those of skill in the art, a fourteen bit address can access up to 16 k locations.

The SIM 14 includes a first logic module 60 and a second logic module 62 coupled to the first logic module 60. The first logic module 60 receives the first address Addr from the CPU 12 and converts the first address Addr to an intermediate address A1. More particularly, if the first address Addr is equal to the address of the indirect data register D[x] 46 (i.e., $0E), then the intermediate address A1 is equal to the contents of the index register 48. Otherwise, the intermediate address A1 is equal to the first address Addr.

The second logic module 62 receives the intermediate address A1 from the first logic module 60 and converts the intermediate address A1 to the memory address A2. Specifically, if the intermediate address A1 is within a predefined range, in this case from $C0 to $FF, then paging is used to access the upper memory. In paging mode, the memory address A2 is the contents of the page select register 50 concatenated with the lower six bits of the intermediate address A1. Thus, in paging, A2=page [7:0]//A1[5:0]. If the intermediate address A1 is not within the predefined range, then the memory address A2 is equal to the intermediate address A1.

As is evident from the foregoing discussion, the present invention provides a low cost, small physical size microcontroller and a method of accessing associated system memory of the microcontroller. The microcontroller has been optimized for small memory sizes. Certain address spaces may be accessed via single instruction words, which allows for efficient coding. The description of the preferred embodiments of the present invention have been presented for purposes of illustration and description, but are not intended to be exhaustive or to limit the invention to the forms disclosed. It will be appreciated by those skilled in the art that changes could be made to the embodiments described above without departing from the broad inventive concept thereof. Various physical implementations of the present invention may be readily utilized. For example, various architectures can be used for the CPU 12. The present invention may be implemented on a single integrated circuit chip, as a system on a chip, or using a plurality of discrete processing systems. Numerous physical implementations may be created to implement any of the specific logic blocks illustrated in the figures. For example, the memory may be implemented as DRAM, SRAM, and Flash and have various physical sizes. Bit widths discussed are implementation specific and bit widths other than as discussed, such as for the instruction word, may be used. The present invention may be implemented in MOS, bipolar, SOI, GaAs or other types of semiconductor processing. The circuitry used to implement the address generator 26 and the SIM 14 may be implemented at various locations within the system. For example, the SIM 14 could be integrated into either the CPU or a memory controller. It is understood, therefore, that this invention is not limited to the particular embodiments disclosed, but covers modifications within the spirit and scope of the present invention as defined by the appended claims.

1. A single chip microcontroller unit (MCU), comprising:
a central processing unit (CPU) that processes eight-bit instructions, each instruction including an instruction operation code (opcode), wherein the opcode designates a function and an addressing mode, and the CPU decodes the opcode to determine the instruction function, the addressing mode, and an operand address, and wherein the CPU supports a tiny addressing mode in which the least significant four bits of the instruction are the operand address, a short addressing mode in which the least significant five bits of the instruction are the operand address, and a direct addressing mode in which the operand address is eight bits that follow the instruction, and wherein the CPU converts the operand address into a first address;
a system integration module (SIM) coupled to the CPU and receiving the first address therefrom, the SIM converting the first address to a memory address; and
a memory coupled to the SIM and the CPU, wherein the memory is accessed using the memory address from the SIM and data stored in the memory is provided to the CPU.

2. The MCU of claim 1, wherein the memory includes a first predetermined address for operating as an indirect data register, and a second predetermined address for accessing an index register, wherein in an indirect addressing mode, the index register contains a memory address and the indirect data register contains a content of the memory address pointed to by the index register.

3. The MCU of claim 2, wherein the memory includes a third predetermined address for accessing a page select register, wherein the page select register is used to define a start of a page being accessed using a page window.

4. The MCU of claim 3, wherein the first, second and third predetermined addresses are within a memory area accessible in the short addressing mode.

5. The MCU of claim 4, wherein the first and second predetermined addresses are within a memory area accessible in the tiny addressing mode.

6. The MCU of claim 3, wherein the CPU comprises:
an opcode decoder that receives each instruction word and decodes the instruction word to form the opcode, determine the addressing mode, and generate the operand address;
a sequencer coupled to the opcode decoder that receives the opcode, determines a function of the instruction and generates ALU control signals;
an arithmetic and logic unit (ALU), coupled to the sequencer, the opcode decoder and the memory, for performing an operation caused by the ALU control signals received from the sequencer; and
an address generator, coupled to the opcode decoder and receiving the operand address therefrom, wherein the address generator converts the operand address into the first address by padding the operand address with a number of leading zeros.

7. The MCU of claim 6, wherein in the tiny addressing mode the address generator pads the operand address with ten leading zeros, in the short addressing mode with nine leading zeros, and in the direct addressing mode with six leading zeros.

8. The MCU of claim 6, wherein the SIM comprises:
a first logic module that receives the first address from the CPU and converts the first address to an intermediate address, wherein if the first address is equal to the first predetermined memory address, then the intermediate address is equal to the contents of the second predetermined memory address, otherwise the intermediate address is equal to the first address; and
a second logic module coupled to the first logic module that receives the intermediate address and converts the intermediate address to the memory address, wherein if the intermediate address is within a predefined range, then the memory address is equal to the content of the third predetermined address concatenated with the least significant six bits of the intermediate address, otherwise the memory address is equal to the intermediate address.

9. The MCU of claim 8, wherein the index register and the page select register are located in the SIM.

10. A microcontroller unit (MCU), comprising:
a memory for storing instructions and data;
a central processing unit (CPU), coupled to the memory, that processes instruction words, each instruction word including an instruction operation code (opcode), wherein the opcode designates a function and an addressing mode, and the CPU decodes the opcode to determine the instruction function, the addressing mode, and an operand address, and wherein the CPU supports a tiny addressing mode for accessing a first predefined range of the memory, a short addressing mode for accessing a second predefined range of the memory, and a direct addressing mode, wherein in the tiny addressing mode the operand address comprises a first number of bits of the instruction word, in the short addressing mode the operand address comprises a second number of bits of the instruction word, and in the direct addressing mode, the operand address comprises a next instruction word, and wherein the CPU converts the operand address to a first address;
a system integration module (SIM) coupled to the memory and the CPU, and receiving the first address from the CPU, the SIM converting the first address to a memory address for accessing the memory; and
a data bus coupling the memory and the CPU, wherein the memory is accessed using the memory address from the SIM and data stored at the memory address is provided to the CPU.

11. The MCU of claim 10, wherein the instruction words are eight bits in length, in the tiny addressing mode the operand address is the least significant four bits of the instruction, and in the short addressing mode the operand address is the least significant five bits of the instruction.

12. The MCU of claim 11, wherein in the tiny addressing mode the CPU pads the operand address with ten leading zeros to generate the first address, in the short addressing mode the CPU pads the operand address with nine leading zeros to generate the first address, and in the direct addressing mode the CPU pads the operand address with six leading zeros to generate the first address.

13. The MCU of claim 12, wherein the memory includes a first predetermined address for operating as an indirect data register, a second predetermined address for accessing an index register, wherein in an indirect addressing mode, the index register contains a memory address and the indirect data register contains a content of the memory address pointed to by the index register.

14. The MCU of claim 13, wherein the memory includes a third predetermined address for accessing a page select register, wherein the page select register is used to define a start of a page being accessed using a page window.

15. The MCU of claim 14, wherein the first, second and third predetermined addresses are within a memory area accessible in the short addressing mode, and the first and second predetermined addresses are within a memory area accessible in the tiny addressing mode.

16. The MCU of claim 14, wherein the SIM comprises:
a first logic module that receives the first address from the CPU and converts the first address to an intermediate address, wherein if the first address is equal to the first predetermined memory address, then the intermediate address is equal to the contents of the second predetermined memory address, otherwise the intermediate address is equal to the first address; and
a second logic module coupled to the first logic module that receives the intermediate address and converts the intermediate address to the memory address, wherein if the intermediate address is within a predefined range, then the memory address is equal to the content of the third predetermined memory address concatenated with the least significant six bits of the intermediate address, otherwise the memory address is equal to the intermediate address.

17. In a microcontroller, a method of accessing an operand stored in a memory, comprising the steps of:
decoding an instruction to determine an opcode and an addressing mode of the instruction, wherein in a tiny addressing mode the opcode indicates that the operand is located in a first predetermined section of the memory, in a short addressing mode the opcode indicates that the operand is located in a second predetermined section of memory; and
generating an operand address, wherein in the tiny addressing mode the operand address is a first predetermined number of bits of the instruction, and in the short addressing mode the operand address is a second predetermined number of bits of the instruction.

18. The method of accessing an operand stored in a memory of claim 17, wherein in the tiny addressing mode, the operand address is the least significant four bits of the instruction, and in the short addressing mode the operand address is the least significant five bits of the instruction.

19. The method of accessing an operand stored in a memory of claim 17, wherein the memory includes a first predetermined address in the first predetermined section of memory for operating as an indirect data register and a second predetermined address in the first predetermined section of memory for operating as an index register, wherein in an indirect addressing mode the index register contains a memory address and the indirect data register contains a content of the memory address pointed to by the index register.

20. The method of accessing an operand stored in a memory of claim 19, wherein the memory includes a third predetermined address located within the second predetermined memory section for operating as a page select register, wherein when the operand address is within a predefined range, then a memory address to be accessed is generated by concatenating a value of the page select register to the operand address.
